(19) United States
(12) Patent Application Publication
(10) Pub. No.: US 2009/0076865 A1
(43) Pub. Date: Mar. 19, 2009

(54) METHODS TO PROVISION, AUDIT AND REMEDIATE BUSINESS AND IT ROLES OF A USER

(76) Inventors: Philip J. Rousselle, Austin, TX (US); Daniel Thomas Greff, Irving, TX (US); Leung Chun, Austin, TX (US); John R. Walker, JR., Kyle, TX (US)

Correspondence Address: BROOKS KUSHMAN P.C. / SUN / STK, 1000 TOWN CENTER, TWENTY-SECOND FLOOR, SOUTHFIELD, MI, 48075-1238, US

(21) Appl. No.: 11/856,148

(22) Filed: Sep. 17, 2007

(51) Int. Cl. G06F 17/50

(52) U.S. Cl. 705/7

(57) ABSTRACT

A business role for a user is selected based on a job title of the user. IT roles are identified based on the selected business role. Provisioned IT roles of the user are compared to the identified IT roles. Differences between the identified and provisioned IT roles are remedied. The differences may be remedied by changing the business role definition.

### BACKGROUND

1. Field of the Invention

The invention relates to methods to provision, audit and remediate business and IT roles of a user.

2. Discussion

In large businesses, identity management software is used to provision the access rights and assets for employees when they begin or change jobs. For example, when an administrative assistant is hired, the identity management system would typically set up their email account and home directory and notify the information technology department to provide a computer and telephone.

An identity management system may be configured with all the company's business roles, e.g., administrative assistant, customer service representative, staff attorney, etc., and all the company's IT roles, or provisionable access rights and assets, e.g., home directory, email account, telephone, etc.

Role Based Access Control (RBAC) is a practice in the field of identity management. An RBAC security analyst studies an organization and divides all the employees into a tractable number of jobs or roles. The access requirements of people within each role are identified. With RBAC, a degree of automation in security administration is possible. When an employee joins the company, leaves the company or changes jobs, a security provisioning tool may be used to automatically grant or revoke the access permissions associated with the employee's role(s).

Analytical methods may be used in business role model design. This approach considers what IT roles are initially assigned to each employee and uses this information as input to a linear programming algorithm that divides the employees into business roles. The following constraints may shape the result: (i) minimize the number of business roles, (ii) maximize the number of IT roles mapped to each business role, and (iii) minimize the number of employees whose IT role requirements differ from their business role definition.

Proper use of analytical methods may require the practitioner to have a thorough knowledge of the mathematical underpinnings of the linear programming techniques employed by the analysis. It may be difficult and costly to find a practitioner with such knowledge. The quality of the result of analytical methods will be reduced if users do not initially have the correct IT role assignments needed to perform their job.

Alternatively, thorough research of an organization that yields a detailed understanding of the duties of its employees may be used in business role model design. This approach may include extensive interviews with large numbers of managers and employees. Once a proposed business role model and business role to IT role mapping is produced, it may go through several reviews by managers and refined based on their input. Thorough research of an organization, however, may be labor intensive and costly.

### SUMMARY

Embodiments of the invention may take the form of a method of determining an identity management strategy. The method includes establishing an initial identity management strategy defined by a plurality of business roles mapped with a plurality of IT roles. The method also includes determining a final identity management strategy via a series of successive approximations. Each approximation includes an audit of provisioned IT roles of users and a remediation of at least one of the identity management strategy and the provisioned IT roles of the users based on the audit.

While exemplary embodiments in accordance with the invention are illustrated and disclosed, such disclosure should not be construed to limit the claims. It is anticipated that various modifications and alternative designs may be made without departing from the scope of the invention.

### BRIEF DESCRIPTION OF THE DRAWINGS

FIG. 1 is a Venn diagram of exemplary provisioning requirements of three employees.

FIG. 2 is a flow chart of an exemplary provisioning strategy.

FIG. 3 is a schematic diagram of an exemplary identity management system and its environment.

FIG. 4 is a flow chart of an exemplary audit and remediation strategy.

FIG. 5 is a flow chart of an exemplary remediation strategy.

FIG. 6 is a state diagram illustrating business role mining through successive approximation.

### DETAILED DESCRIPTION

The effectiveness of the business and IT role relationship as represented by an identity management system may determine its usefulness. Objectives that may be considered include: (i) each user should be granted the access rights and assets needed to do their job, an no others, and (ii) the process of defining and maintaining the mapping of business roles to IT roles should be efficient enough such that the costs of configuring the identity management software do not over shadow the benefits of using it.

If automated provisioning performs the correct provisioning tasks in most cases, then the need to manually provision or de-provision a small number of IT roles for a small number of users may be tolerated. While there may be a great deal of commonality in the requirements of all users in a common business role, exceptions may arise. For example, a few administrative assistants who work for executives may need laptop computers, while the rest may only need desktop computers. In this case, a determination should be made as to whether it is more efficient to treat administrative assistants as a single business role and deal with the special needs of executive administrative assistants as exceptions, or whether executive administrative assistants constitute a separate business role.

Role mining is the process of dividing an organization's employees into business roles that have common or near common access requirements. Role mining may be important to the configuration of an identity management system. For example, if too many business roles are defined, then defining and maintaining the requirements of each business role can become as difficult as defining the requirements of each individual user. If too few business roles are defined, then each time a user joins the organization or changes jobs, many of their requirements will have to be dealt with as exceptions rather than being automatically provisioned by the identity management software.

It may not be possible to group large numbers of users into job categories with identical security requirements. For example, two employees with the same job title may legitimately have different access requirements, e.g., permanent versus temporary administrative assistants. While it may be possible to handle a small number of situations like this by dividing one role into two—such as breaking the administrative assistant role into permanent administrative assistant and temporary administrative assistant—the number of roles can quickly become unmanageable. The phenomenon of having an excessive number of roles to accommodate slightly different employee needs with a single job title may be called “roll explosion.”

Some techniques described herein remedy role explosion by recognizing that, for any given role, there are some access rights that must always be granted, e.g., administrative assistants are always granted email access, there are some access rights that may sometimes be granted, e.g., administrative assistants sometimes are granted remote access, and there are some access rights that should not be granted, e.g., administrative assistants should not have access to the HR database.

### Business Roles and IT Roles

A challenge in identity management is mapping hundreds of users into a sea of resource access permissions. The result should insure that each user has access to the resources they need to do their job, and no others. Further, this should be accomplished in such a way that the cost and disruption associated with security administration are containable. Additionally, identity management may not be limited to security issues. It may extend to all IT assets and access privileges that must be provisioned and deprovisioned as employees join, leave and change jobs within an organization.

Asking each manager to assess which assets and access permissions should be granted to each employee is likely to be inefficient and ineffective. Some techniques described herein map employees to their duties, and duties to the resources required to carry them out. Further, techniques described herein seek to exploit the high degree of commonality that may exist among people doing similar work—that is, all the employees in a given business role—while making it easy to accommodate legitimate requirements that are not universal. Some examples of the business roles that are commonly found in organizations include Customer Service Representative, Customer Service Manager, Administrative Assistant, Sales Representative, and HR Specialist.

Just as understanding the common IT needs of a given business role leads to more effective management of those requirements, understanding how a given resource is deployed can facilitate its management. Employee productivity and enterprise security are enhanced by provisioning and de-provisioning resources when needed. Therefore, it is useful to examine how IT resources satisfy IT roles. For example, many employees need desktop telephones. While provisioning a phone involves several steps, e.g., assigning a number, adding a voice mail account, etc., this level of granularity is only of interest to the technician installing the phone. Identity management is concerned with identifying when phones need to be provisioned and de-provisioned and managing the communications so that these activities are performed when needed.

The IT roles performed by IT resources may be visible to users as assets, software and access. Examples of “Asset” like IT roles include pager, cell phone, and computer. Examples of “Software” like IT roles include word processing software, spread sheet software, and calendar software. Examples of “Access” type IT roles include remote access, home directory, and shared drive.

Conceptualizing the IT landscape in terms of business and IT roles reduces the complexity of identity management. The task is no longer to map hundreds of employees into a sea of security permissions. It now involves designing meaningful business and IT roles and understanding how these roles relate to each other, the organization, its employees and assets.

### Required, Manual and Conditional Activations

When a new employee joins an organization, they will be assigned a business role as a part of the hiring process. When they arrive, it is up to the identity management solution to insure that the IT roles needed for their job, and no others, are available to them. The identity management system's knowledge of what IT roles are always, sometimes or never required by each business role may facilitate this process. Such knowledge may be derived by an analysis of a large number of people in each role.

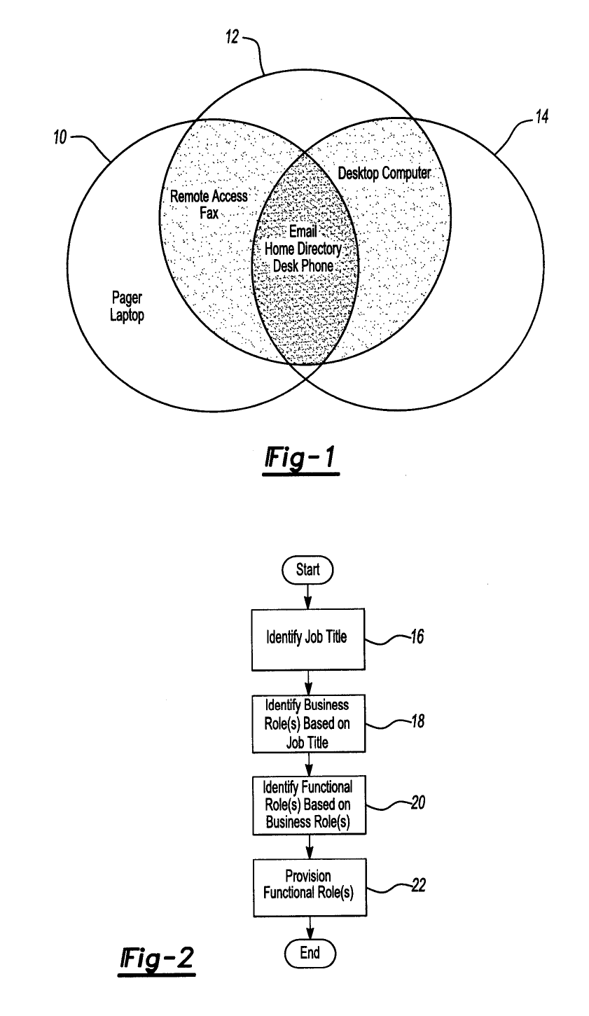

FIG. 1 shows the results of an analysis of three hypothetical administrative assistants 10, 12, 14 using techniques described herein. This analysis shows that all the administrative assistants 10, 12, 14 require email, a home directory and desk phone. As soon as a new administrative assistant is hired, the identity management software's provisioning engine can, based on information in the HR database, initiate the activation of these IT roles. These activations can be accomplished either by interacting with the underlying systems—to allocate a home directory, for example—or by sending emails or opening trouble tickets with the help desk or resource owners. The provisioning of IT roles that are granted to all employees in a given business role are considered required activations.

Some IT roles required by an employee may not be determined strictly based on their business role. Some of these, however, can still be automatically provisioned by identity management software based on other information in the HR database. For example, if remote access is granted to all permanent administrative assistants but withheld from contractors, the identity management software can check for contractor status in the HR records and provision remote access without human intervention in cases where it is indicated. This is an example of a conditional activation. That is, the identity management software automatically provisions remote access for administrative assistants conditioned on whether or not they are permanent employees.

Still other IT roles are provided to employees based solely on the discretion of a manager or other authority. Examples include the provisioning of pagers or laptop computers to administrative assistants based on the requirements of the tasks to which they have been assigned. Human intervention with the identity management system may be needed to affect these manual activations. A manager or other authority logs into the identity management system—possibly after being prompted by an automated email message to do so—and selects which manual IT role activations will be required for the new employee.

### Access Approval Procedures

In cases where an IT role involves access to a sensitive resource, like the HR database, the identity management system allows for establishment of access approval procedures. In one example, when a sensitive IT role is manually assigned by a manager, notification of the activation is sent to a designated resource owner for approval. The resource owner logs into the identity management system and approves the activation before it proceeds. As part of the approval, the resource owner may specify a sunset date at which time access is to be de-provisioned if it is not re-approved.

### Automation Architecture

Once an organization's identity management strategy has been framed in terms of business roles, IT roles, and access approval procedures, software automation and tools can be used to facilitate IT administration.

FIG. 2 shows an example flow chart for an identity management automation solution. At 16, a job title is identified. At 18, business roles are identified based on the job title. At 20, IT roles are identified based on the business roles. At 22, the IT roles are provisioned.

Business roles may be contained, implicitly or explicitly, in each employee's HR record. In cases where there is an unambiguous mapping between each employee's department or job code and their business role, there may not need to be any additional identity management information in the HR database. When this mapping is not possible, an explicit business role designation may be included in each employee's HR record at the time of hiring and maintained throughout their employment. In either case, the addition, transfer or separation of an employee in the HR database triggers associated business role activations and/or deactivations in the identity management system.

The identity management system may determine which IT roles are to be provisioned when an employee is hired and a business role is activated. Required and conditional IT roles to be provisioned may be identified based on the contents of the HR record. “Candidate” manual IT roles may also be associated with each business role. In one example, the decision as to which manual IT roles will actually be activated for any particular user is made by a human. The identity management system may send an email or other communication to the responsible person asking them to log into an identity management GUI and select the manual IT roles. Once the selections are made, emails are sent to the appropriate approvers asking them to log into an approval process GUI and respond to the access requests.

After manual IT role selections have been made and approvals received, IT role provisioning can proceed. This provisioning is performed or managed by the provisioning engine. This both relieves human managers of a tedious task and reduces the possibility that any necessary provisioning activities will “fall through the cracks.”

In addition to new-hire provisioning, identity management activities associated with employee separations and transfers can also be automated because they can be triggered by updates to the HR database. Deprovisioning of IT roles can be performed or initiated without human interaction. Automated de-provisioning has a significant security benefit. Failure to promptly and completely de-provision terminated employees can leave an organization vulnerable to various types of retailation and malicious activities.

### Auditing, Recertification and Remediation

A concern of identity management may be insuring that the correct provisioning and deprovisioning activities are performed as people join, leave or change responsibilities within an organization. It may also be desirable to periodically verify that each user has the assets and access privileges they need, and no others. Identity management systems provide auditing tools for this purpose. In some cases, the identity management software is integrated with the IT resources and can retrieve the audit information directly. In other cases, it will request that IT personnel, through email, trouble tickets, or an identity management GUI, supply it. This process of determining what access rights and assets have been assigned to which users is called an audit scan. The asset and access information is used to determine which IT roles have been assigned to each person. Once a user's actual IT roles are known, these are compared to their business roles. Cases of non-compliance may be documented.

Besides verifying each user's currently assigned IT roles, it may also be necessary to establish that no user's duties have changed in a way that would cause their business role information in the identity management system to be inaccurate. To accomplish this, managers are periodically asked to recertify the business roles assigned to each employee.

When auditing or recertifying detects a mismatch between an employee's business and IT roles, remediation may be needed to restore compliance. This remediation may take several forms. The user may have IT roles granted or revoked. The need for this type of remediation is often caused by provisioning errors. If the duties assigned to an employee have changed substantially, their business role designation may also need to change. A business role definition may be inaccurate. For example, a company may begin providing laptops and remote access to administrative assistants without adding remote access as a required IT role for the administrative assistant business role.

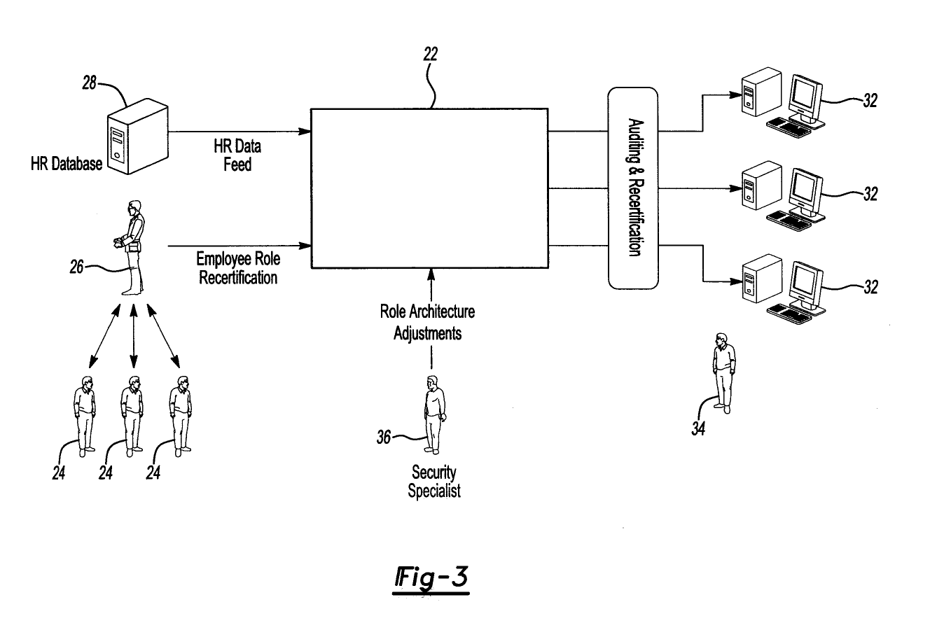

FIG. 3 illustrates an example identity management system 22 within an organization. Employees 24 and managers 26 interact with each other to obtain a clear understanding of each employee's responsibilities. The manager 26, at re-certification time, insures that these facts are reflected in the user's business role and manual IT role assignments. The identity management system 22, based on input from the managers 26 and HR records 28, interacts with IT systems 32, through direct interaction or communication with IT personnel 34, to grant or revoke assets and access rights to employees to support their assigned duties. A security specialist 36, as described below, may ensure acceptable mappings between business and IT roles.

### Role Mining

Implementing an identity management strategy may be challenging. Initially, the enterprise may be regarded as a population of users who have been granted assets and access permissions on an ad-hoc basis. Role mining is a process used to devise a business and IT role strategy that will insure that every existing user is assigned the correct IT roles. The goals of moving from ad-hoc access and asset assignment to rigorous identity management may include improved administration, security and compliance, reduced complexity and increased efficiency.

Introducing an identity management regime to a company includes identifying their IT roles. This may involve studying the provisioning requests between managers and IT provisioning staff to define the granularity of access and asset requests to be managed. If managers normally request laptops for employees, then this suggests a single IT role. If managers instead request laptops for some employees and wi-fi enabled laptops for other employees, then this suggests two IT roles.

Once the universe of IT roles has been identified, business roles may be defined. This may a complex task in a large organization. Narrowly defined business roles may result in employees being assigned several business roles. Small changes in duties will require business role reassignment. The business role structure will be difficult to audit and maintain. Broadly defined business roles may result in complex conditional IT roles. Managers may have to choose from a large number of manual roles for each employee.

Business role mining seeks to group users into business roles in a way that will minimize the number of business roles, maximize the number of required IT roles, and minimize the number of conditional and manual roles. These criteria may not be of equal importance. Their relative weighting may vary from one organization to another.

One conventional approach to business role mining is to consider how IT roles have been assigned to users on and ad-hoc basis and to try—without modifying the IT role assignments—to assign users to business roles in a way that accomplishes all the criteria listed above. This bottoms-up approach lends itself to an analytic solution. That is, the criteria may be used as objectives in a combinatorial optimization problem whose solution is the definition of business roles and the assignment of users to those roles. A variety of algorithms are available to find a solution. This approach, however, is limited by the quality of the original data. If the organization had been very careful to insure that each employee has only the assets and access permissions they need, then it may be possible to extrapolate a useful business role architecture from the existing IT role assignments. It is more often the case, however, that the existing functional assignments are not completely correct. The fact that an organization is implementing a rigorous identity management solution suggests that they were not realizing acceptable results with their ad-hoc methodology. If users had been under- or over-provisioned in the past, then this “noise” will be incorporated into an analytically derived business role architecture.

Another conventional approach is to enlist the services of an experienced identity management expert to engineer the business role architecture. Such a professional will meet with various stake holders such as managers, application owners, provisioners, IT staff and representative employees to glean a top-down understanding of the enterprise. Based on this research, he will propose a business role architecture. Once initial business roles are defined, along with their associated required, conditional and manual IT roles, each employee is assigned one or more business roles. This process, however, is time intensive and requires the support of the individuals being interviewed.

An audit scan determines how a company's IT role provisioning deviates from its business role strategy. Conventional approaches use audit scans to ensure that provisioned IT roles match the IT roles defined by the analytically computed or engineered business roles.

### Successive Approximation

Unlike conventional approaches, successive audit scans may be used to derive the business role/IT role relationships. For example, an initial identity management strategy (business/IT role mapping) may be constructed by an identity management expert based on a cursory examination of an organization's HR job titles and brief discussions with a small number of managers and employees. Once this first approximation is in place, an initial audit scan may be performed to determine how the company's ad-hoc provisioning deviates from what was expected. Based on the results of this initial scan, remediation may be performed. This first remediation exercise may involve both extensive employee re-provisioning and significant adjustments to the business role architecture. After the first audit and attempt at employee re-provisioning and business role modifications, another audit scan may be performed. This second scan may show substantial progress towards compliance. This cycle of audits and remediations constitutes a process of business role mining through successive approximation.

Once the initial business role architecture is in place, the organization may start using identity management tools for the provisioning, re-provisioning and de-provisioning associated with employee hiring, transfers and separations. That is, the refinement of the business role architecture may proceed after the initial business role definitions have been put into production. The identity management system will simply become more effective as the business roles and user permissions are refined.

An example of designing user roles through successive approximation is as follows. It is first assumed that a company has only salesmen and engineers. It is further assumed that salesmen will have access to sales databases and engineers will have access to engineering databases. A first audit scan shows that half the salesmen have access to the European sales database and the other half have access to the American sales database. Based on this information, the salesmen role is divided into American salesmen and European salesmen. The European salesmen will have access to the European sales database and the American salesmen will have access to the American sales database. This process is repeated until an audit scan reveals a satisfactory result.

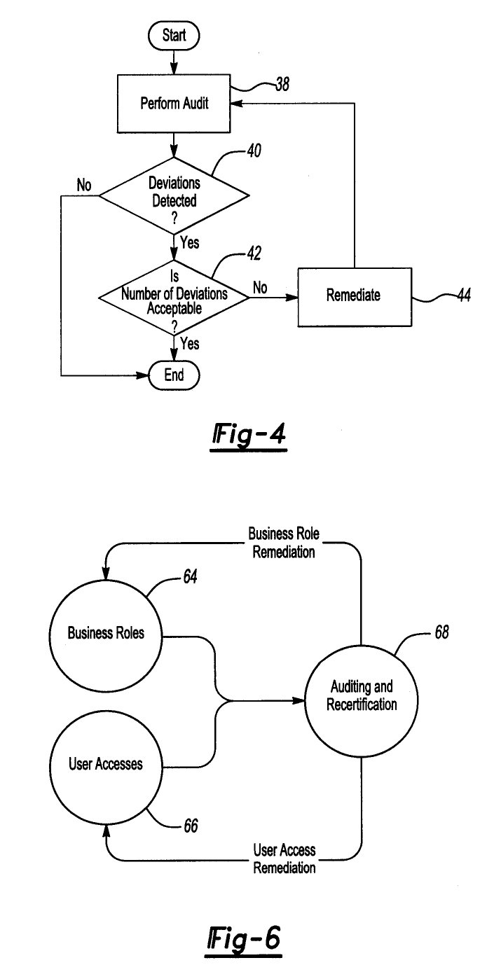

FIG. 4 shows an example audit and remediation strategy. At 38, an audit scan is performed. At 40, it is determined whether deviations are detected. If no, the strategy ends. If yes, at 42, it is determined whether the number of deviations are acceptable. If yes, the strategy ends. If no, at 44, remediation is performed.

FIG. 5 shows an example remediation strategy. At 46, it is determined whether the deviation should be ignored. If no, at 48, it is determined whether the deviation is due to a provisioning error. If yes, at 50, the provisioning error is corrected. If no, at 52, it is determined whether the deviation is due to a business role definition error. If yes, at 54, the business role definition is corrected. If no, at 56, it is determined whether the business role can be changed. If yes, at 58, the business role is changed. If no, at 60, a new business role is created. Referring to step 46, if yes, at 62, it is determined whether there is another deviation. If yes, the strategy returns to step 46 is yes. If no, the strategy ends. Following any of steps 50, 54, 58, 60, the strategy proceeds to 62.

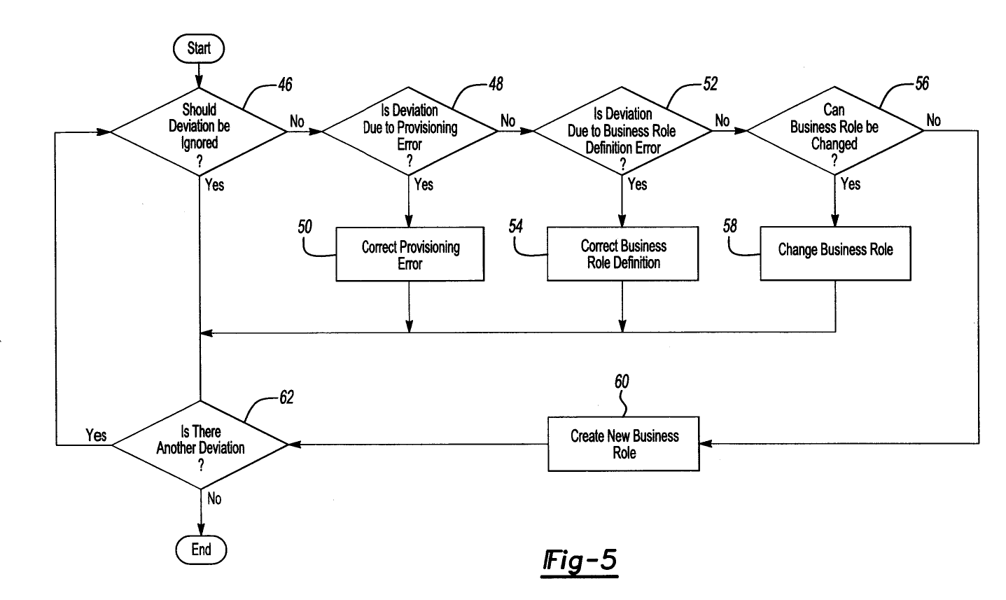

FIG. 6 shows business role mining through successive approximation. Business roles 64 and user accesses 66 are audited and recertified at 68. Business role remediation is used to remediate the business roles 64. User access remediation is used to remediate the user accesses 66. This process proceeds iteratively until the desired business role definitions are achieved.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method of determining an identity management strategy for users having provisioned IT roles, the method comprising:
establishing an initial identity management strategy defined by a plurality of business roles mapped with a plurality of IT roles; and
determining a final identity management strategy via a series of successive approximations by iteratively auditing the provisioned IT roles of the users and remediating at least one of the identity management strategy and the provisioned IT roles of the users based on the audit.

2. The method of claim 1 wherein remediating at least one of the identity management strategy and the provisioned IT roles of the users based on the audit includes altering the mapping of the plurality of business roles with the plurality of IT roles.

3. The method of claim 1 wherein remediating at least one of the identity management strategy and the provisioned IT roles of the users based on the audit includes altering the provisioned IT roles of the users.

4. The method of claim 1 wherein each iteration of auditing the provisioned IT roles includes comparing the provisioned IT roles with the plurality of IT roles defined by the identity management strategy.

5. The method of claim 2 wherein altering the mapping of the plurality of business roles with the plurality of IT roles includes creating a new business role.

6. The method of claim 1 further comprising selecting a business role for each of the users based on a job title of each of the users.

7. A method for auditing and remediating a business role definition of a user, the method comprising:
selecting a business role for the user wherein the business role has a predefined set of IT roles associated with the business role;
identifying provisioned IT roles of the user;
determining whether the provisioned IT roles deviate from the predefined set of IT roles associated with the business role; and
altering at least one of the business role of the user and the predefined set of IT roles associated with the business role if the provisioned IT roles deviate from the predefined set of IT roles, thereby auditing and remediating a business role definition of a user.

8. The method of claim 7 wherein altering the predefined set of IT roles includes associating and additional IT role with the business role of the user.

9. The method of claim 7 wherein altering the predefined set of IT roles includes disassociating at least one IT role of the predefined set of IT roles from the business role.

10. The method of claim 7 wherein altering the business role of the user includes selecting another business role for the user.

11. The method of claim 7 wherein altering the business role of the user includes selecting an additional business role for the user.

12. The method of claim 7 wherein altering the business role of the user includes creating a new business role for the user.

13. The method of claim 7 wherein the business role of the user is selected based on a job title of the user.

14. The method of claim 7 wherein the business role of the user is selected based on data about the user.

15. A method for provisioning IT roles for a user comprising:
assigning a business role to the user;
selecting an IT role based on the business role;
determining whether the user meets a predefined condition; and
provisioning the IT role for the user if the user meets the predefined condition.

16. The method of claim 15 further comprising identifying an additional IT role based on the business role and requesting permission to provision the additional IT role for the user.

17. The method of claim 16 further comprising receiving permission to provision the additional IT role and provisioning the additional IT role for the user.

18. The method of claim 17 further comprising requesting permission to maintain the provisioned additional IT role for the user after a predetermined period of time.

19. The method of claim 17 further comprising de-provisioning the additional IT role after a predetermined period of time.

20. The method of claim 15 further comprising determining whether the user meets an additional predefined condition and de-provisioning an IT role for the user if the user meets the additional predefined condition.
